(19) United States
(12) Patent Application Publication
(10) Pub. No.: US 2002/0193901 A1
(43) Pub. Date: Dec. 19, 2002

(54) Exposure apparatus and method

(75) Inventor: Kazuya Kikuchi, Tochigi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/167,691

(22) Filed: Jun. 13, 2002

(30) Foreign Application Priority Data
Jun. 15, 2001 (JP) 2001-181842

(51) Int. Cl. G06F 19/00

(52) U.S. Cl. 700/121; 716/21

(57) ABSTRACT

Disclosed is an exposure apparatus in which number of light pulses emitted per unit time, inclusive of a light-emission quiescent period (non-light-emission period) during exposure, is calculated before the start of exposure, or the number of light pulses emitted per unit time, the temperature of the light source or the quality of the emitted light is measured during exposure, and the timing of the pulsed light emission or the intensity of the pulsed light emission is controlled in such a manner that the calculated value or measured value will not become a value that degrades the image properties of the exposure apparatus.

### FIELD OF THE INVENTION

This invention relates to an exposure apparatus for exposing a photosensitive substrate to a pattern on a mask or reticle by pulsed light from a pulsed light source such as a pulsed laser. More particularly, the invention relates to an exposure apparatus used to manufacture devices such as ICs and other semiconductor elements, liquid crystal elements and the like.

### BACKGROUND OF THE INVENTION

In an exposure apparatus used when manufacturing devices such as semiconductor elements and liquid crystal elements employing photolithography techniques, a circuit pattern written on a reticle or photomask is exposed to and burned in a photosensitive substrate, such as a wafer or glass plate coated with a photoresist or the like, via a projection optical system.

The packing density of semiconductor elements and the like has increased in recent years and this has been accompanied by a demand to improve the resolution of the exposure apparatus. In order to improve resolution, there is an exposure apparatus that uses a pulsed-laser light source of the far ultraviolet region, such as an excimer laser, as a light source having a shorter wavelength. The exposure operation in an exposure apparatus that uses a pulsed laser is carried out by irradiating a wafer, which has been coated with a photosensitive material such as a photoresist, with a plurality of laser pulses via a reticle and a projection optical system. The overall energy of the laser pulses that irradiate a certain point on the wafer during exposure is the amount of exposure of one shot at this point. In order to obtain an optimum and constant resolution and pattern line width of the circuit pattern on the reticle whose image is formed on the wafer, it is required that stabilized exposure control be carried out in such a manner that the amount of exposure of the shot be the optimum value with respect to the photosensitive material such as the photoresist, and such that any disparity in the amount of exposure between shots be small. The value of exposure energy per pulse of the pulsed laser varies in accordance with a set parameter value (e.g., value of applied voltage) applied to the laser device when the laser oscillates to produce pulses. By changing the set value, therefore, it is possible to control the exposure energy.

In a sequentially shifted demagnifying-type exposure apparatus referred to as a stepper, the reticle pattern is projected onto the wafer upon being demagnified to one-fourth or one-fifth of the original size, and a stage on which the wafer is mounted is moved sequentially whenever one shot of exposure is performed, whereby a single wafer is subjected to pattern exposure of multiple shots. With the conventional exposure apparatus, wafer size is enlarged, the number of shots capable of being exposed on a single wafer is increased and the traveling speed of the stage is raised, thereby raising throughput, namely the number of devices that can be produced by the exposure apparatus per unit time. In order to raise throughput even further, however, it is necessary also to increase the output of the pulsed-laser light source, i.e., to increase the laser pulse energy capable of being output per unit time.

An increase in the output of the pulsed-laser light source can be achieved by raising the pulse frequency of the laser without lowering the pulse energy per pulse of the laser.

Among the pulsed-laser light sources available, the excimer laser, which is used in the manufacture of semiconductor elements, generates pulsed laser light by performing high-output pulse discharge in the gas chamber of the laser. The pulse discharge requires a very high voltage and a large amount of heat is produced from the laser chamber owing to the charging and discharging operation. If a pulsed output having a higher repetition frequency is performed continuously in order to increase the output of the pulsed laser, the temperature of the laser device rises owing to the large amount of heat given off by the laser chamber. This has a deleterious effect upon the optical quality of the output laser light, e.g., upon the energy characteristic and wavelength characteristic, thereby degrading the properties of the reticle pattern image exposed in the exposure apparatus.

In order to improve cooling performance for the purpose of suppressing a rise in temperature, it has been contemplated to increase the flow rate of a coolant supplied to the laser device, lower the temperature of the coolant or dissipate heat produced in a laser environment other than one relying upon a coolant. However, this results in a coolant supply apparatus of greater size, an increase in the size of the laser device itself, an increase in the size of facilities for air conditioning the room in which the laser is used and a major increase in cost.

### SUMMARY OF THE INVENTION

Accordingly, an object of the present invention is to raise the throughput of an exposure apparatus by increasing the output of a pulsed-laser light source without raising the cost of the facilities in the exposure apparatus environment.

According to the present invention, the foregoing object is attained by so arranging it that when exposing light is emitted from a light source and the pattern on a reticle is transferred to a photosensitive substrate by exposing the substrate to the pattern, it is determined whether a condition that the optical quality of the exposing light emitted by the light source has declined has been met, and the emission of the exposing light is controlled based upon the result of the determination so as to suppress a decline in the optical quality of the light source.

Preferably, it is determined whether a condition that the temperature of the light source has risen has been met and the emission of the exposing light is controlled based upon the result of the determination so as to suppress a rise in the temperature of the light source.

Preferably, the exposure apparatus has a stage that can be moved with respect to a demagnifying exposure optical system while holding the photosensitive substrate, wherein the stage is moved sequentially to expose a plurality of areas of the photosensitive substrate to the pattern, which has been formed on the reticle, via the demagnifying projection optical system.

Preferably, in control of the light emission, the light source is one which produces a pulsed light emission, and a control unit causes the light source to produce a pulsed light emission at a predetermined timing and controls the timing of the pulsed light emission upon comparing the number of light pulses emitted per unit time with a predetermined number of pulses.

Preferably, in control of the light emission, the number of light pulses emitted per unit time is calculated based upon the pulsed light emission time of the light source and traveling time of the stage.

Preferably, in control of the light emission, if the number of light pulses emitted per unit time exceeds the predetermined number of pulses, the light-emission frequency of the light source is lowered, a light-emission quiescent period is provided or an existing light-emission quiescent period is prolonged.

Preferably, in control of the light emission, the light source is one which produces a pulsed light emission and the light-emission intensity of the light source is controlled based upon a parameter value applied to the light source. If the number of light pulses emitted per unit time exceeds the predetermined number of pulses, the light-emission intensity of the light source is reduced by changing the parameter value.

Preferably, in control of the light emission, the control unit calculates the number of light pulses emitted per unit time based upon the pulsed light emission time of the light source and the traveling time of the stage.

Preferably, in control of the light emission, the parameter value is a value of voltage applied to the light source.

Preferably, in control of the light emission, the number of light pulses emitted per unit time is calculated before start of the exposure operation.

Preferably, in control of the light emission, the number of light pulses emitted per unit time is counted.

Preferably, in control of the light emission, temperature or optical quality of the light source is measured and the timing of the pulsed light emission is controlled in such a manner that the temperature or optical quality of the light source will not fall outside a predetermined range.

Preferably, in control of the light emission, temperature or optical quality of the light source is measured and, if the temperature or optical quality of the light source falls outside the predetermined range, the light-emission intensity of the light source is reduced by changing the parameter value.

Preferably, in control of the light emission, the parameter value is a value of voltage applied to the light source.

Preferably, the exposure apparatus further comprises a warning unit for outputting a warning signal. If the temperature or optical quality of the light source falls outside the predetermined range in control of the light emission, the warning unit outputs the warning signal.

The present invention is applicable also to a method of manufacturing a semiconductor device comprising the steps of installing a group of manufacturing apparatus for various processes in a semiconductor manufacturing plant, and manufacturing a semiconductor device by a plurality of processes using the group of manufacturing apparatus; wherein the group of manufacturing apparatus includes an exposure apparatus having: a determination unit for determining whether a condition that the optical quality of the exposing light emitted by the light source has declined has been met, wherein the light source emits exposing light for transferring a pattern on an exposure reticle to a photosensitive substrate by exposing the substrate to the pattern; and a control unit for controlling emission of the exposing light based upon the result of the determination so as to suppress a decline in the optical quality of the light source.

Further, the present invention is applicable also to a semiconductor manufacturing plant comprising: a group of manufacturing apparatus for various processes inclusive of an exposure apparatus; a local-area network for interconnecting the group of manufacturing apparatus; and a gateway for making it possible to access, from the local-area network, an external network outside the plant; whereby information relating to at least one of the manufacturing apparatus in the group thereof can be communicated by data communication; the exposure apparatus having: a determination unit for determining whether a condition that the optical quality of the exposing light emitted by the light source has declined has been met, wherein the light source emits exposing light for transferring a pattern on an exposure reticle to a photosensitive substrate by exposing the substrate to the pattern; and a control unit for controlling emission of the exposing light based upon the result of the determination so as to suppress a decline in the optical quality of the light source.

Further, the present invention is applicable also to a method of maintaining an exposure apparatus installed in a semiconductor manufacturing plant, the exposure apparatus having a determination unit for determining whether a condition that the optical quality of the exposing light emitted by the light source has declined has been met, wherein the light source emits exposing light for transferring a pattern on an exposure reticle to a photosensitive substrate by exposing the substrate to the pattern; and a control unit for controlling emission of the exposing light based upon the result of the determination so as to suppress a decline in the optical quality of the light source; the method comprising the steps of: providing a maintenance database, which is connected to an external network of the semiconductor manufacturing plant, by a vendor or user of the exposure apparatus; allowing access to the maintenance database from within the semiconductor manufacturing plant via the external network; and transmitting maintenance information, which is stored in the maintenance database, to the side of the semiconductor manufacturing plant via the external network.

Further, the present invention is applicable also to an exposure apparatus comprising: a determination unit for determining whether a condition that the optical quality of the exposing light emitted by the light source has declined has been met, wherein the light source emits exposing light for transferring a pattern on an exposure reticle to a photosensitive substrate by exposing the substrate to the pattern; and a control unit for controlling emission of the exposing light based upon the result of the determination so as to suppress a decline in the optical quality of the light source; the exposure apparatus further comprising a display, a network interface and a computer for executing network software, wherein maintenance information relating to the exposure apparatus is capable of being communicated by data communication via a computer network.

More specifically, the number of light pulses emitted per unit time, inclusive of a light-emission quiescent period (non-light-emission period) during exposure, or the intensity of the light emission, is calculated before the start of exposure, or the number of light pulses emitted per unit time, the temperature of the light source or the quality of the emitted light is measured during exposure, and the timing of the pulsed light emission or the intensity of the pulsed light emission is controlled in such a manner that the calculated value or measured value will not become a value that degrades the image properties of the exposure apparatus.

In accordance with the above-described arrangement, even if the pulsed light-emission frequency and pulsed light-emission intensity that are optimum for throughput are set without initially taking into account the temperature rise and optical quality of the light source, the pulsed light-emission timing or pulsed light-emission intensity of the light source is controlled automatically at the time of exposure in such a manner that the image quality of the exposure apparatus will not be degraded. Accordingly, exposure is carried out under the optimum conditions for throughput within limits that will not degrade the image quality of the exposure apparatus. On the other hand, in a case where the image quality of the exposure apparatus declines with the current prevailing pulsed light-emission timing and pulsed light-emission intensity, the pulsed light-emission timing or pulsed light-emission intensity of the light source is controlled automatically to prevent the production of a defective article owing to degradation of exposure-apparatus image quality caused by an excessive rise in the temperature of the light source. In this case also, therefore, exposure is carried out under better conditions for throughput. As a result, throughput of the exposure apparatus can be raised by increasing the output of a pulsed-laser light source without raising the cost of the facilities in the exposure apparatus environment.

Further, the above-described exposure apparatus is characterized in that when the exposure operation starts, the laser output necessary for exposure of one shot is calculated from the amount of exposure needed for burn-in, then the laser output per predetermined time is calculated from the traveling time between shots, i.e., the laser quiescent period between shots, based upon the screen size of the exposure shot and the traveling speed of the stage carrying the wafer, and the output frequency of the laser pulses or the voltage applied to the laser is adjusted, a quiescent period is provided between the exposure shots or the charging voltage of the laser chamber is lowered in such a manner that the calculated value of the laser output becomes a value that will not allow the temperature of the laser to rise.

By using the above-described exposure apparatus, the output of the pulsed laser can be raised to the maximum extent possible without raising the cost of coolant supplied to the laser device or of facilities that cool the laser device, and the throughput for manufacturing semiconductor elements can be raised.

Other objects and advantages besides those discussed above shall be apparent to those skilled in the art from the description of a preferred embodiment of the invention which follows. In the description, reference is made to accompanying drawings, which form apart thereof, and which illustrate an example of the invention. Such example, however, is not exhaustive of the various embodiments of the invention, and therefore reference is made to the claims which follow the description for determining the scope of the invention.

### BRIEF DESCRIPTION OF THE DRAWINGS

FIG. 1 is a diagram schematically illustrating an exposure apparatus according to first to third embodiments of the present invention;

FIG. 2 is a layout diagram of an exposure shot when a wafer is exposed to a reticle pattern;

FIG. 3 is a timing chart useful in describing the operation of the exposure apparatus when an exposure operation is executed;

FIGS. 4A and 4B are timing charts useful in describing duty cycles of laser oscillation and quiescence during an exposure operation;

FIG. 5 is a flowchart useful in describing the operation of a controller in the first embodiment;

FIGS. 6A and 6B are timing charts useful in describing a method of measuring a laser-emission pulse count and oscillation duty ratio of a laser when an exposure operation is executed according to the second and third embodiments;

FIG. 7 is a flowchart useful in describing the operation of a controller in the second embodiment;

FIG. 8 is a flowchart illustrating a timer interrupt operation executed in an interval T₀ during the operation illustrated by the flowchart of FIG. 7;

FIG. 9 is a diagram schematically illustrating an exposure apparatus according to a fourth embodiment of the present invention;

FIG. 10 is a timing chart useful in describing laser oscillation and fluctuation in laser temperature and optical quality during an exposure operation;

FIG. 11 is a timing chart useful in describing operation of a controller in the fourth embodiment;

FIG. 12 is a conceptual diagram of a semiconductor device production system using the apparatus according to the embodiment, viewed from an angle;

FIG. 13 is a conceptual diagram of the semiconductor device production system using the apparatus according to the embodiment, viewed from another angle;

FIG. 14 is a particular example of user interface;

FIG. 15 is a flowchart showing device fabrication process; and

FIG. 16 is a flowchart showing a wafer process.

### DESCRIPTION OF THE PREFERRED EMBODIMENTS

Embodiments of the present invention will now be described with reference to the drawings.

[First Embodiment]

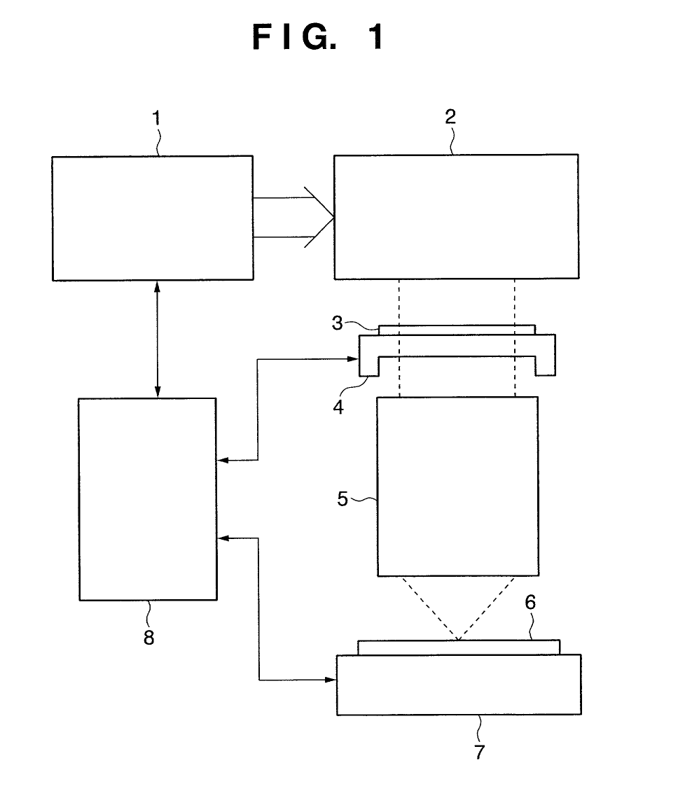

FIG. 1 is a diagram schematically illustrating an exposure apparatus according to a first embodiment of the present invention.

As shown in FIG. 1, the exposure apparatus includes a pulsed-laser light source 1, in which a gas such as KrF is sealed, for generating laser light. The light source 1 generates pulsed light having a wavelength in the far ultraviolet region. An illumination optical system 2 comprises a beam shaping optical system, an optical integrator, a collimator and mirrors (not of which are shown). The beam shaping optical system is form forming the laser beam into a desired shape, and the optical integrator is for uniformalizing the light distribution characteristic of the light flux. The circuit pattern of a semiconductor element to undergo exposure has been formed on a reticle 3 illuminated by the illumination optical system 2. A reticle stage 4 carrying the reticle 3 is moved in the horizontal direction, thereby making it possible to move the reticle 3 horizontally in two dimensions. A demagnifying optical system 5 demagnifies the circuit pattern image of the reticle 3 and projects the demagnified image onto a wafer 6. A wafer stage 7 carries the wafer 6. The wafer 6 and wafer stage 7 are arranged in such a manner that the wafer 6 can be moved in the horizontal direction by moving the wafer stage 7 horizontally in two dimensions.

A controller 8 applies an pulse oscillation command to the pulsed-laser light source 1, whereby a prescribed number of laser pulses is output at a predetermined timing. At this time a parameter value such as a value of charging voltage is applied to the pulsed-laser light source 1 simultaneously so that it is also possible to control the output value. Further, the controller 8 applies drive commands to the reticle stage 4 and wafer stage 7, whereby it is possible to drive the reticle 3 and wafer 6 to prescribed positions at predetermined timings.

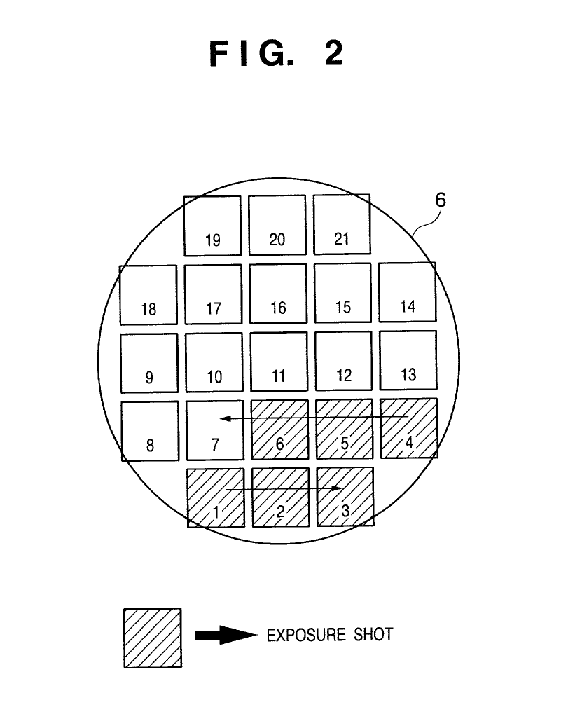

FIG. 2 shows the manner in which the circuit pattern of the reticle 3 is demagnified and projected onto the wafer 6 by the demagnifying optical system 5 in the exposure apparatus. In this plan view of the wafer 6, each of the square areas indicated at 1 to 21 represents the area of the pattern image on the reticle 3 exposed by a single shot. In this illustrated example, the single wafer 6 is exposed to 21 shots of pattern image of reticle 3.

Numerals 1 to 21 in FIG. 2 denote the order of exposure. The operation for exposing the wafer 6 includes first having the wafer stage 7 drive the wafer 6 in such a manner that the exposure area 1 of the first shot arrives directly below the demagnifying optical system 5, and having the pulsed-laser light source 1 output a prescribed number of light pulses at this position to thereby expose the first shot. Next, the wafer stage 7 drives the wafer 6 in such a manner that the exposure area 2 of the second shot arrives directly below the demagnifying optical system 5, and the pulsed-laser light source 1 outputs a prescribed number of light pulses at this position to thereby expose the second shot. Thenceforth, and in similar fashion, the driving of the wafer stage 7 and the output of pulsed light from the pulsed-laser light source 1 are repeated alternatingly to complete the exposure of 21 shots.

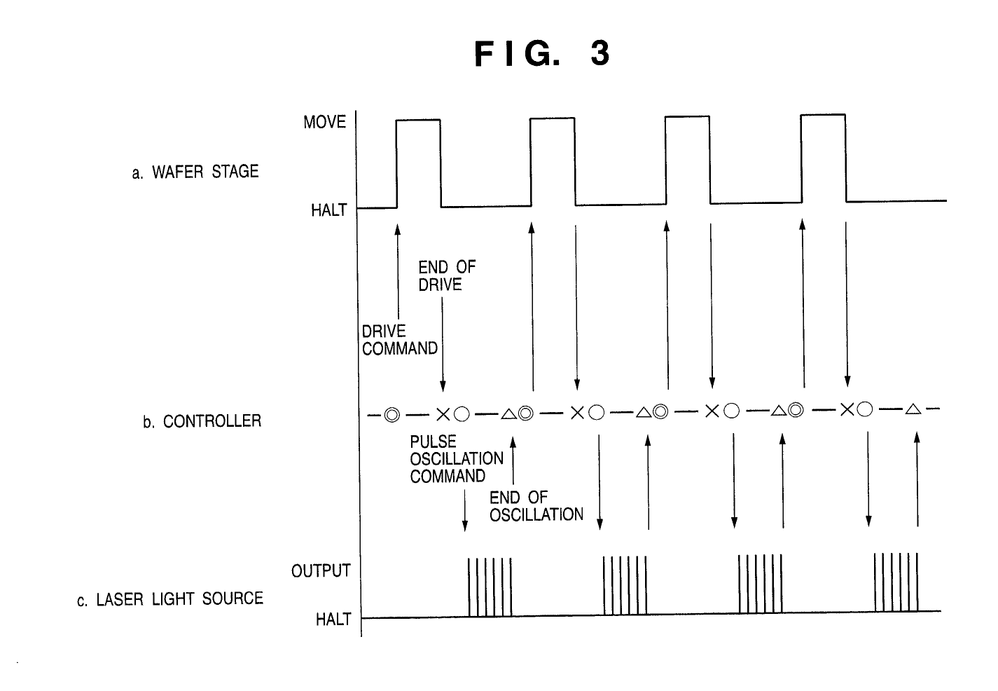

FIG. 3 is a timing chart illustrating the flow of the above-described exposure apparatus. In FIG. 3, a indicates movement and halting of movement of the wafer stage 7; b indicates commands from the controller 8 for actuating the pulsed-laser light source 1 and wafer stage 7, as well as sensing of end of operation; and c indicates output and halting of output of light pulses from the pulsed-laser light source 1. In the exposure operation, first the controller 8 generates a command to drive the wafer stage 7 to the position of exposure area 1 of the first shot in FIG. 2 at the timing indicated by ⊙. Upon receiving the drive command, the wafer stage 7 is driven to the position of exposure area 1. When drive to the exposure position ends, the wafer stage 7 so notifies the controller 8. The latter senses end of driving of the wafer stage 7 at the timing indicated by X, then immediately issues a laser pulse oscillation command to the pulsed-laser light source 1 at the timing indicated by ∘. Upon receiving the oscillation command, the pulsed-laser light source 1 outputs pulsed laser light. In the example of FIG. 3, six laser pulses are output. Next, at the timing indicated by Δ, the controller 8 receives notification of end of pulse oscillation from the pulsed-laser light source 1, thereby sensing timing of end of pulse oscillation. Exposure of the first shot ends with this operation. Detection of pulse oscillation end timing may be performed upon obtaining the product of laser pulse oscillation frequency and number of output pulses.

Immediately after the end of exposure of the first shot is detected, the controller 8 issues a command to the wafer stage 7 to drive the stage to the position of exposure area 2 of the second shot in FIG. 2. Thereafter, and through an operation similar to that for the first shot, the controller 8 repeatedly performs the operations for detecting end of driving of the wafer stage 7, issuance of the oscillation command to the pulsed-laser light source 1 and detection of end of pulse oscillation. When exposure of all 21 shots ends, exposure of the entire wafer 6 is completed.

When exposure of the entire wafer is completed, a wafer exchange device, which is not shown in the arrangement of the exposure apparatus depicted in FIG. 1, exchanges an unexposed wafer for the exposed wafer. This is followed by repeating the exposure operation for this next wafer.

One important property of an exposure apparatus is semiconductor-device productivity. This is defined as the number of wafers that can be exposed per unit time and is referred to as throughput. In order to raise the throughput of an exposure apparatus, it will suffice to shorten the traveling time of the wafer stage 7 between exposure shots, the laser oscillation time of the pulsed-laser light source 1 per exposure shot and the wafer exchange time. To shorten laser oscillation time, the optimum amount of exposure necessary for each exposure shot is decided based upon the pattern on the reticle 3 exposed and the photosensitivity of the photo resist coating on the wafer 6, etc., and energy in line with this optimum amount of exposure is applied to the wafer 6 by irradiation with a plurality of laser light pulses, thereby exposing each shot. Accordingly, in order to shorten laser oscillation time for each exposure shot, the energy of the pulsed-laser light source 1 per pulse should be made larger and the number of pulses needed to attain the optimum exposure should be reduced or the pulse oscillation frequency should be increased. In general, however, the pulsed-laser light source 1, such as an excimer laser, is such that the magnitude of pulse energy per generated pulse exhibits an uncontrollable variation, and a histogram of a plurality of pulse energy values tends to have a normal distribution about the average value. Therefore, reducing the number of generated pulses by raising the energy per laser pulse is disadvantageous in that it leads to a comparatively greater contribution of exposure error that is caused by a variation in the energy of each pulse occupying the amount of exposure of one shot. If the precision with which the optimum amount of exposure is attained in each exposure shot is taken into consideration, therefore, it is preferred that the laser oscillation time be shortened by exploiting the effect of averaging energy variation by increasing the pulse oscillation frequency of the pulsed-laser light source 1 without reducing the number of pulses. If the oscillation frequency of the laser is doubled, it is possible to reduce laser oscillation time by half.

However, among the pulsed-laser light sources available as the pulsed-laser light source 1, an excimer laser used in manufacture of semiconductor elements generates pulsed laser light by performing a high-output pulse discharge within a sealed chamber containing a rare gas such as KrF and a halogen-element compound. The pulse discharge requires a very high voltage of 20 to 30 kV, and the laser chamber produces a large amount of heat owing to this charging and discharging operation. The pulsed-laser light source 1 usually dissipates heat by circulating a high-pressure coolant through the interior of the apparatus, thereby suppressing the temperature rise of the laser device. However, if a pulsed output of a higher frequency is performed continuously to raise the output of the pulsed laser without changing cooling performance, the laser chamber will produce a greater amount of heat, the temperature of the pulsed-laser light source 1 will rise and this will have a deleterious effect upon the optical quality of the output laser light. This degrades the image properties of the pattern image on the reticle 3 to which the wafer 6 is exposed.

In order to suppress the temperature rise of the pulsed-laser light source 1, it is contemplated to increase the flow rate of a coolant supplied to the pulsed-laser light source 1, lower the temperature of the coolant or dissipate heat produced in a laser environment other than one relying upon a coolant. However, this results in a coolant supply apparatus of greater size, an increase in the size of the laser device itself, an increase in the size of facilities for air conditioning the room in which the laser is used and a major increase in cost.

In an exposure apparatus, however, as described in connection with FIG. 3, during an ordinary exposure operation the laser is not made to oscillate continuously for an extended period of time. Between exposures, there is a period of time during which the wafer stage 7 is moved. In this period of time the lasing operation of the pulsed-laser light source 1 is halted so that the heat produced during exposure can be dissipated. Even though the laser oscillation frequency is raised to perform the exposure operation, the amount of increase in the heat produced by the pulsed-laser light source 1 ascribed to the increase in laser oscillation frequency produced at the time of lasing can be dissipated during travel of the wafer stage 7 owing to the ratio of traveling time of the wafer stage 7 to laser oscillation time. Hence there are instances where a rise in the temperature of the pulsed-laser light source 1 does not occur even though there is no enhancement of cooling performance commensurate with the increase in laser output.

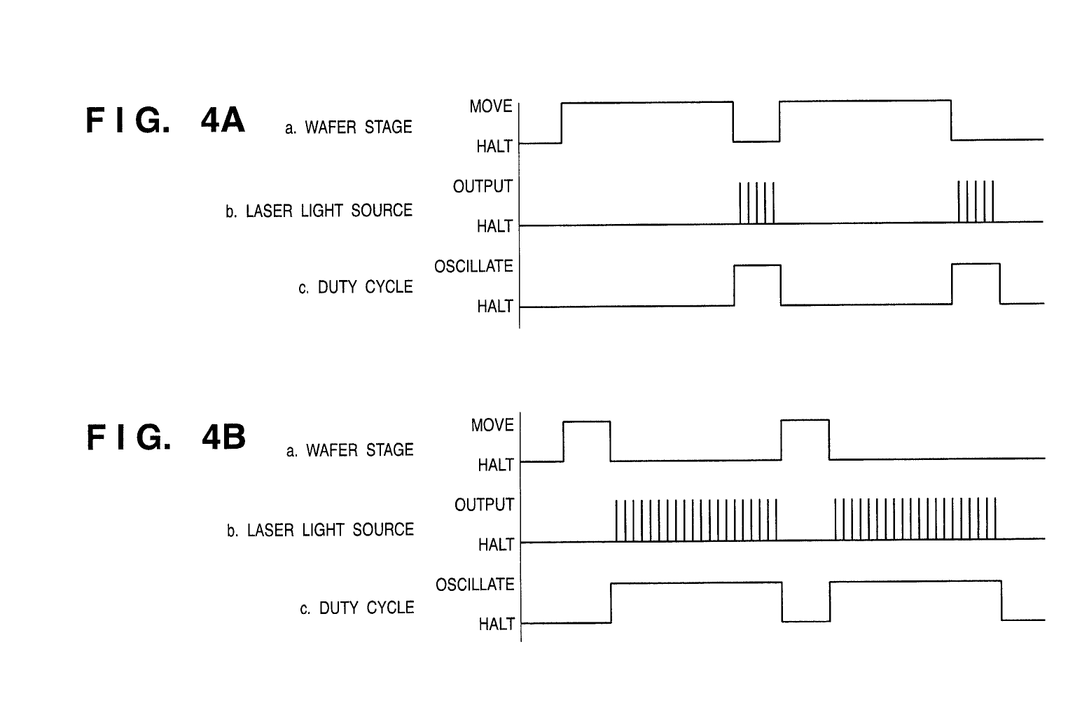

FIG. 4A is a timing chart of an exposure operation in a case where the ratio of traveling time of the wafer stage 7 to the oscillation time of the pulsed-laser light source 1 is large. In FIG. 4A, a indicates operation of the wafer stage 7, b the pulsed-light output of the pulsed-laser light source 1 and c the duty cycle of laser oscillation. For example, when the circuit pattern size of a semiconductor device formed on the reticle 3 is increased, the size of pattern image projected upon the wafer 6, namely the exposure area of each shot, also increases proportionally, so does the traveling distance of the wafer stage 7 between exposure shots, and so does the traveling time. Furthermore, when photosensitivity of the photoresist coating the wafer 6 is high, the number of generated laser pulses necessary for exposure of one shot declines. When these conditions are taken into account, the duty ratio of laser oscillation time in the overall exposure operation time diminishes and even if exposure is performed upon raising the laser oscillation frequency, excessive heat produced can be dissipated during movement of the wafer stage 7, i.e., during the quiescent period of laser oscillation. This makes it possible to achieve an improvement in throughput based upon a higher laser oscillation frequency without enhancing cooling performance.

Similarly, FIG. 4B is a timing chart of an exposure operation in a case where the ratio of traveling time of the wafer stage 7 to the oscillation time of the pulsed-laser light source 1 is small. In contradistinction to the example of FIG. 4A, the pattern image on the wafer 6, namely the exposure area, becomes comparatively small when the circuit pattern size of the semiconductor element formed on the reticle 3 is small, and therefore the traveling distance of the wafer stage 7 between exposure shots and the traveling time between these shots also decrease. Furthermore, when photosensitivity of the photoresist coating the wafer 6 is low, the number of generated laser pulses necessary for exposure of one shot declines. When these conditions are taken into account, the duty ratio of laser oscillation time in the overall exposure operation time increases. If there is no enhancement of cooling performance, excessive heat produced by performing exposure upon raising the laser oscillation frequency cannot all be dissipated within the laser-oscillation quiescent period during which the wafer stage 7 is being moved. As a consequence, a temperature rise occurs in the pulsed-laser light source 1 and the optical quality of the laser light declines. This results in reduced burn-in capability of the exposure apparatus.

Accordingly, a duty ratio of laser oscillation/quiescence or number of laser oscillation pulses per unit time that will not allow the temperature of the pulsed-laser light source 1 to rise even if the laser oscillation frequency (frequency of the pulsed light emission) is increased is ascertained in advance, the laser oscillation time is calculated prior to the start of exposure from the laser pulse count, which is found based upon the optimum amount of exposure necessary for the exposure shot, and from the oscillation frequency of which the pulsed-laser light source 1 is capable. Furthermore, the traveling time of the wafer stage 7 between shots is calculated from the traveling distance of the wafer stage 7 between shots, which is found from the size of the image pattern on the reticle 3 to which the wafer 6 is exposed and the traveling speed of the wafer stage 7, and the value of the duty ratio of laser oscillation/quiescence or the value of the number of laser oscillation pulses per unit time is estimated from the calculated values. It is determined whether the estimated value will cause the temperature of the pulsed-laser light source 1 to rise. In case of a value that will not cause such a temperature rise, exposure is carried out at the laser oscillation frequency estimated. On the other hand, in case of a value that will cause a temperature rise in the pulsed-laser light source 1, an exposure operation that will not lead to a temperature rise is carried out. For example, the laser oscillation frequency is made lower than the initial value, or additional laser-oscillation quiescent time is provided between exposure shots, or the value of charging voltage set at the time of laser pulse oscillation is lowered.

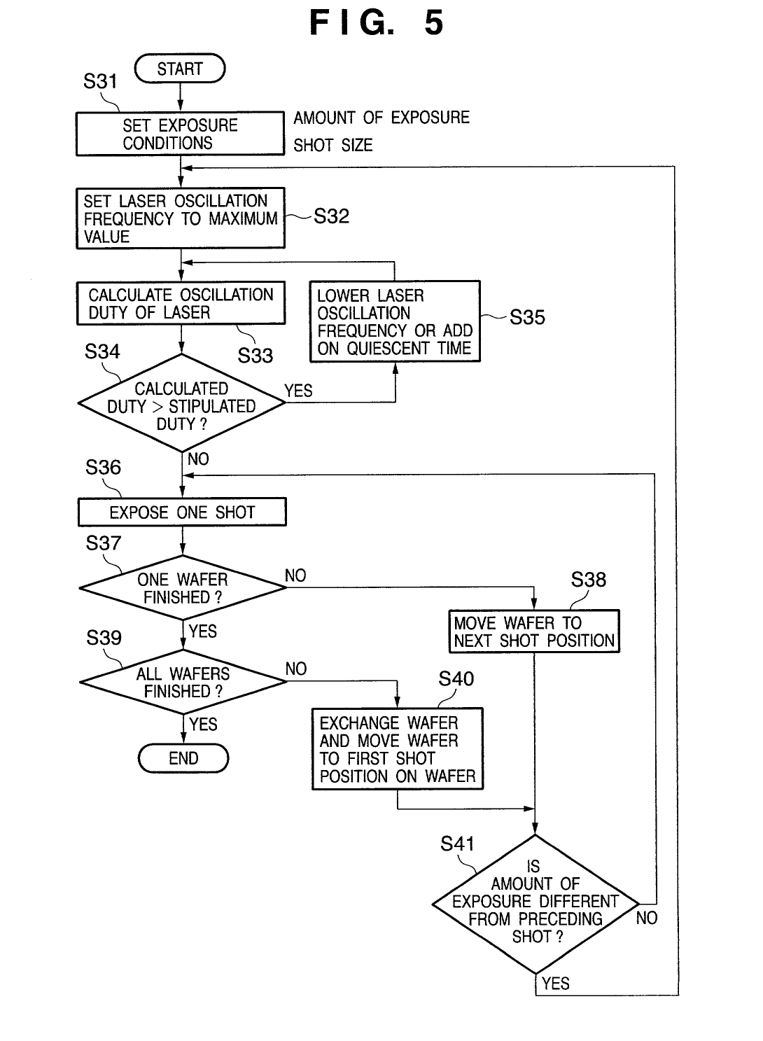

FIG. 5 is a flowchart useful in describing the exposure operation performed by the exposure apparatus of FIG. 1.

When such exposure conditions as amount of exposure and shot size are set (step S31), the laser oscillation frequency is set to the maximum value (step S32). Next, oscillation duty of the laser is calculated (step S33). If the calculated duty is not greater than a predetermined stipulated duty (“NO” at step S34), then exposure of one shot is performed (step S36) leaving the oscillation frequency at the maximum value, as described above with reference to FIG. 4A. If the calculated duty is greater than the stipulated duty (“YES” at step S34), on the other hand, the laser oscillation frequency is lowered or additional quiescent time is provided (step S35) in such a manner that the calculated duty will fall below the stipulated duty, as described with reference to FIG. 4B, and then exposure of one shot is performed. After the exposure of one shot, it is determined whether exposure of one wafer is finished (step S37). If exposure is not finished (“NO” at step S37), then the wafer is moved to the next shot position (step S38) and exposure of one shot is carried out. If exposure of one wafer is finished (“YES” at step S37), however, then it is determined whether exposure of all wafers is finished (step S39). If an unexposed wafer is still left (“NO” at step S39), a wafer exchange is made (step S40), the unexposed wafer is moved to the first shot position in on this wafer and the one shot is exposed. If no unexposed wafers are left (“YES” at step S39), the exposure operation is terminated. It should be noted that if the amount of exposure of a shot to be exposed differs from that of the preceding shot (“YES” at step S41) after the wafer is moved to the next shot position (step S38) or after the wafer is exchanged and the new wafer is moved to the first shot position (step S40), then, before one shot is exposed, the above-described processing is executed. That is, the laser oscillation frequency is set to the maximum value, the laser oscillation duty is calculated, the calculated duty and the stipulated density are compared and, if necessary, the laser oscillation frequency is lowered or the addition quiescent time is provided.

[Second Embodiment]

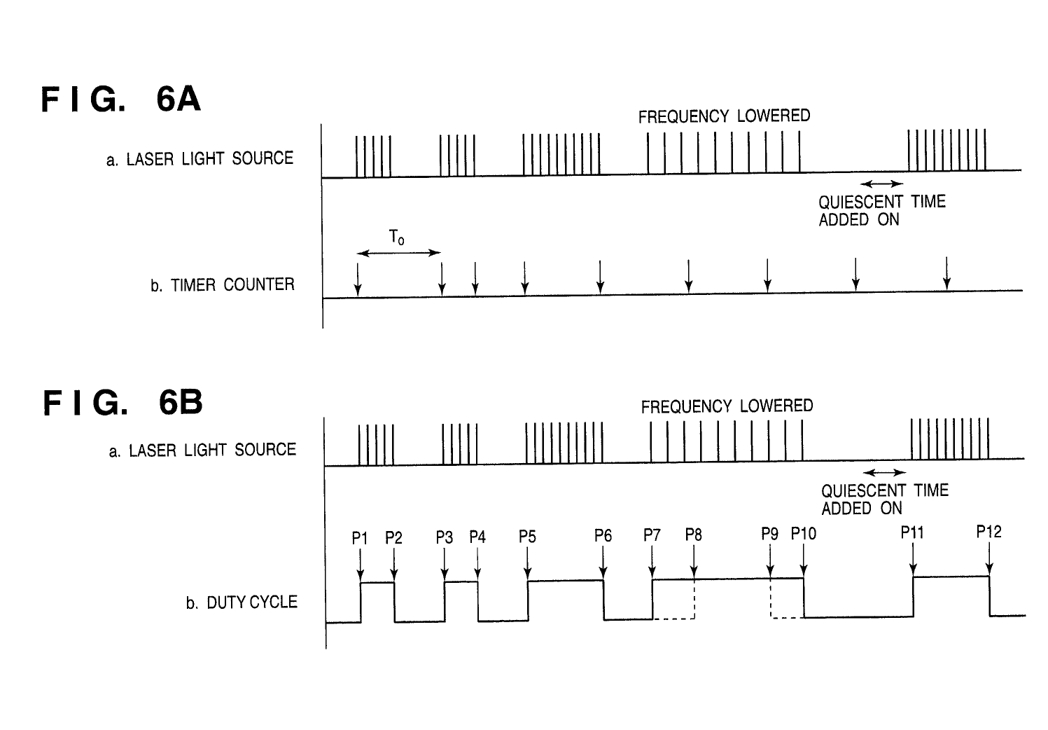

FIG. 6A is a timing chart of the exposure operation of an exposure apparatus according to a second embodiment of the present invention. The general structure of the exposure apparatus is the same as that shown in FIG. 1. The exposure sequence shown in FIG. 3 is implemented similarly also in the exposure apparatus of this embodiment.

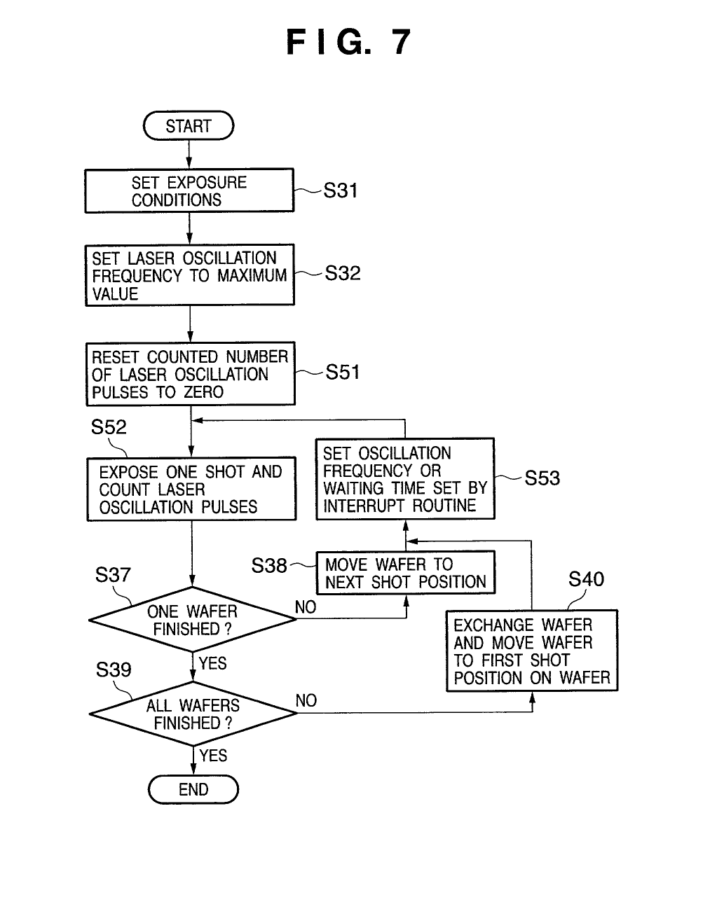

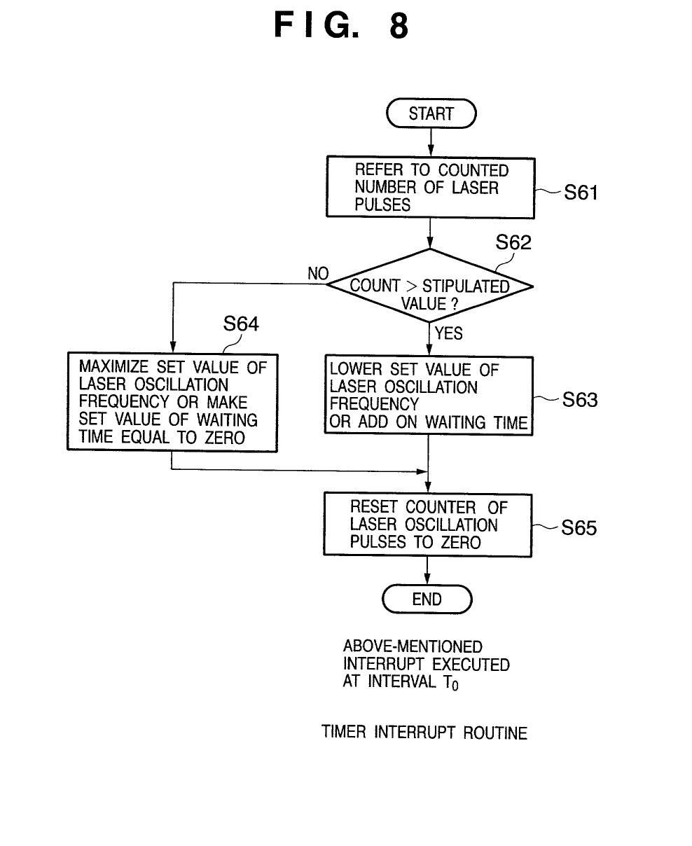

In FIG. 6A, a indicates the timing at which laser pulses are generated by the laser light source 1 and b the timing at which the controller 8 counts the laser pulses. FIGS. 7 and 8 are flowcharts useful in describing the exposure operation performed by the controller 8. Here processing steps identical with those of the first embodiment are designated by like step numbers.

During the exposure operation, the controller 8 constantly counts the number of laser oscillation pulses within a time interval T₀ (steps S51, S52). The controller 8 previously stores a limit oscillation-pulse count Pt of such value that a temperature rise in the laser light source 1 will not occur even though the laser light source 1 generates laser pulses during the unit time T₀. If the number of oscillation pulses counted over time T₀ is equal to or less than Pt (step S61; “NO” at step S62), the controller 8 judges that the temperature of the laser light source 1 has not risen and continues the exposure operation at the present oscillation frequency of the laser pulses (step S64). On the other hand, if the number of oscillation pulses counted over the time T₀ exceeds Pt (step S61; “YES” at step S62), then the controller 8 judges that a temperature rise has occurred in the laser light source 1 and executes an exposure operation that will not cause the temperature to rise (steps S53, S63). For example, the controller 8 makes the laser oscillation frequency at the time of exposure lower than the initial value, or provides additional laser-oscillation quiescent time between exposure shots, or lowers the value of charging voltage set at the time of laser pulse oscillation.

[Third Embodiment]

FIG. 6B is a timing chart of the exposure operation of an exposure apparatus according to a third embodiment of the present invention. In the second embodiment described above, the number of oscillation pulses in unit time T₀ is counted and the oscillation frequency or waiting time is adjusted in accordance with the value of the count, as illustrated in FIG. 8. According to the third embodiment, however, the duty ratio of pulse oscillation is calculated based upon a laser oscillation command from the controller 8 and notification of end of oscillation from the laser light source 1, and the oscillation frequency or waiting time is adjusted in accordance with the value calculated.

In FIG. 6B, a indicates the timing at which laser pulses are generated by the laser light source 1 and b the oscillation duty cycle of the laser pulses. The controller 8 detects laser-oscillation start times (P1, P3, P5, P7, P11) and laser-oscillation end times (P2, P4, P6, P10, P8) in FIG. 6B and calculates the duty ratio of laser oscillation time during the exposure operation from the laser oscillation times (P1 to P2, P3 to P4, etc., in FIG. 6B) and laser quiescent times (P2 to P3, P4 to P5, etc. in FIG. 6B). Furthermore, the controller 8 previously stores a limit laser oscillation duty ratio Dt of such value that a temperature rise in the laser light source 1 will not occur. If the measured duty ratio is equal to or less than Dt, the controller 8 judges that the temperature of the laser light source 1 has not risen and continues the exposure operation at the present oscillation frequency of the laser pulses. On the other hand, if the measured duty ratio exceeds Dt, then the controller 8 judges that a temperature rise has occurred in the laser light source 1 and executes an exposure operation that will not cause the temperature to rise. For example, the controller 8 makes the laser oscillation frequency at the time of exposure lower than the initial value, or provides additional laser-oscillation quiescent time between exposure shots, or lowers the value of charging voltage set at the time of laser pulse oscillation. Further, in a case where the controller 8 detects a duty ratio that exceeds Dt and performs the exposure operation upon lowering the laser oscillation frequency or reducing the charging voltage value, the evolution of heat by the laser light source 1 is mitigated with regard to the actual laser-oscillation start times and end times and therefore the controller 8 calculates an effective duty ratio using oscillation start and end times (P8, P9 in FIG. 6B) that are effective for such evolution of heat.

[Fourth Embodiment]

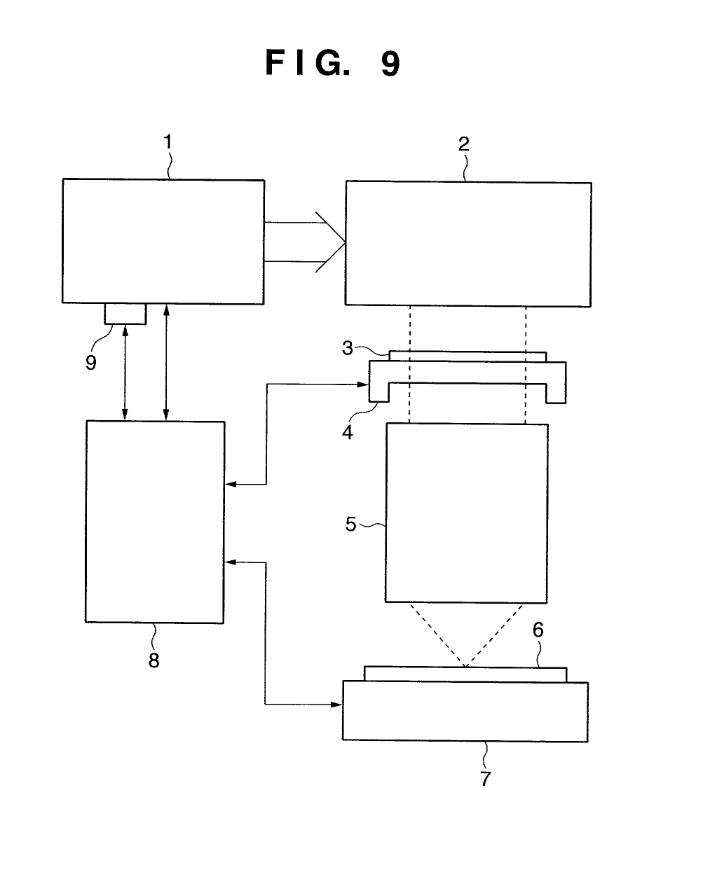

FIG. 9 is a diagram schematically illustrating an exposure apparatus according to a fourth embodiment of the present invention. As in the exposure apparatus described with reference to FIG. 1, this exposure apparatus also includes the pulsed-laser light source 1, the illumination optical system 2, the reticle stage 4 carrying the reticle 3, the demagnifying optical system 5, the wafer stage 7 carrying the wafer 6, and the controller 8. The apparatus according to this embodiment further includes a sensor 9 for sensing temperature or the optical quality of the laser beam. This arrangement measures a fluctuation in the temperature of the pulsed-laser light source 1 or in the optical quality of the laser beam, outputs a warning signal, which is based upon the measured temperature or optical quality or fluctuation in the temperature or optical quality of the pulsed-laser light source 1, indicating the possibility that the image properties of the pattern image burned in by the exposure apparatus may be adversely affected if the laser oscillation operation is continued under these conditions, and enables this to be monitored by the controller 8. The exposure sequence shown in FIG. 3 is implemented similarly also in the exposure apparatus of this embodiment.

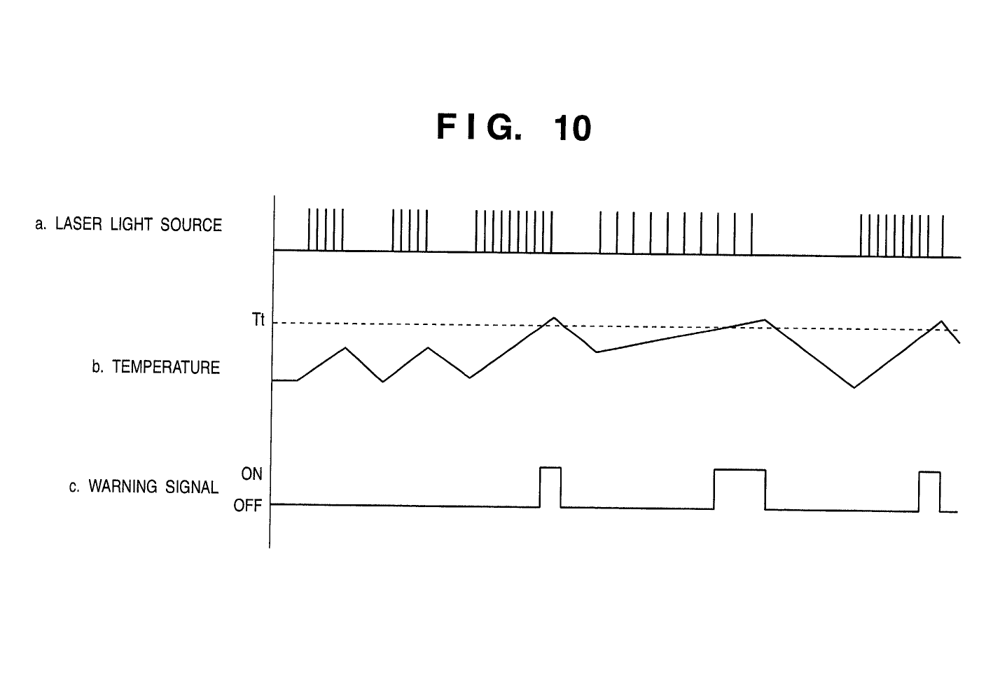

In FIG. 10A, a indicates the timing at which laser pulses are generated by the laser light source 1, b the status of the laser light source 1 whose temperature or optical quality is monitored by the sensor 9, and c the status of the warning signal that the laser light source 1 applies to the exposure apparatus via the output of the sensor 9. The controller 8 monitors the status of the pulsed-laser light source 1 measured by the sensor 9 during the exposure operation, compares this with a previously stored limit value T1 at which an adverse effect will not be imposed upon the optical quality of the pulsed light output from the pulsed-laser light source 1 and continues the exposure operation at the prevailing laser-pulse oscillation frequency if the monitored value is equal to or less than Tt. If the monitored value exceeds Tt, on the other hand, then the controller 8 executes an exposure operation that will not allow the value to be exceeded. For example, the controller 8 makes the laser oscillation frequency at the time of exposure lower than the initial value, or provides additional laser-oscillation quiescent time between exposure shots, or lowers the value of charging voltage set at the time of laser pulse oscillation.

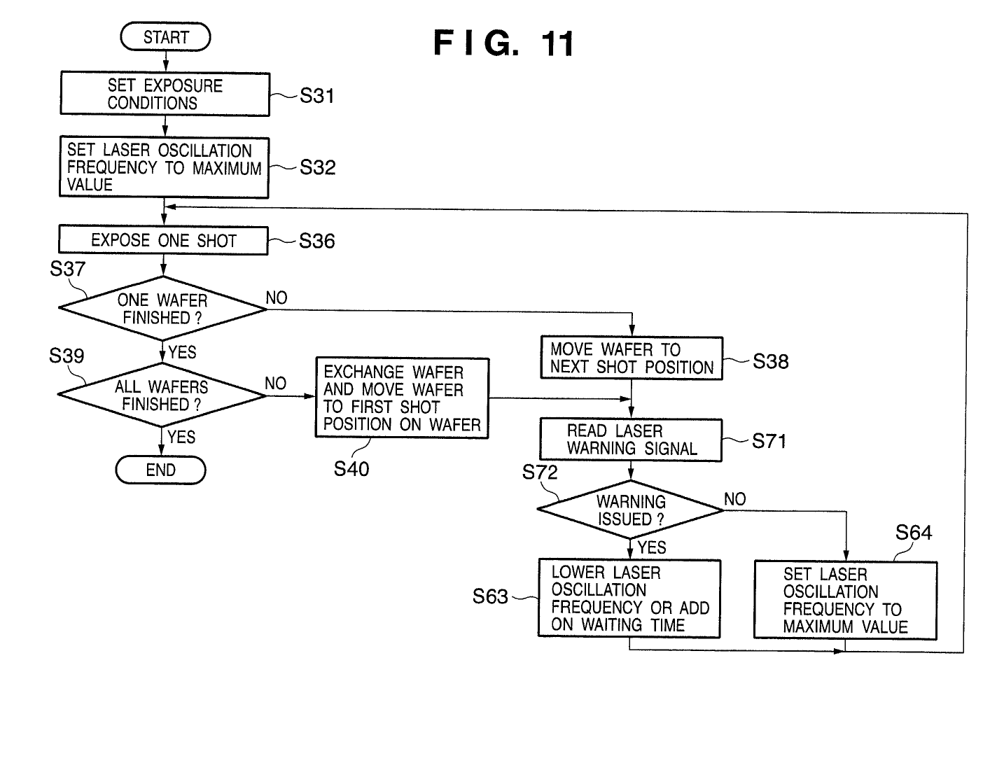

Alternatively, as illustrated by the operation of the controller 8 shown in FIG. 11 (in which processing identical with that of the first and second embodiments is indicated by like processing steps), the controller 8 monitors the warning signal (step S71) that the pulsed-laser light source 1 outputs through the status of the sensor 9 during the exposure operation. If the warning signal is in the OFF state (“NO” at step S72), the status of use is such that the optical quality of the pulsed light output from the pulsed-laser light source 1 will not be adversely affected. Accordingly, the controller 8 continues the exposure operation using the currently prevailing laser-pulse oscillation frequency. On the other hand, if the warning signal is in the ON state (“YES” at step S72), then the controller 8 executes an exposure operation that will not allow the optical quality of the laser pulses to decline. For example, the controller 8 makes the laser oscillation frequency at the time of exposure lower than the initial value, or provides additional laser-oscillation quiescent time between exposure shots, or lowers the value of charging voltage set at the time of laser pulse oscillation.

(Embodiment of Semiconductor Production System)

Next, an example of semiconductor device (semiconductor chip of IC, LSI or the like, a liquid crystal panel, a CCD, a thin film magnetic head, a micromachine etc.) production system using the apparatus of the present invention will be described. The system performs maintenance services such as trouble shooting, periodical maintenance or software delivery for fabrication apparatuses installed in a semiconductor manufacturing factory, by utilizing a computer network outside the fabrication factory.

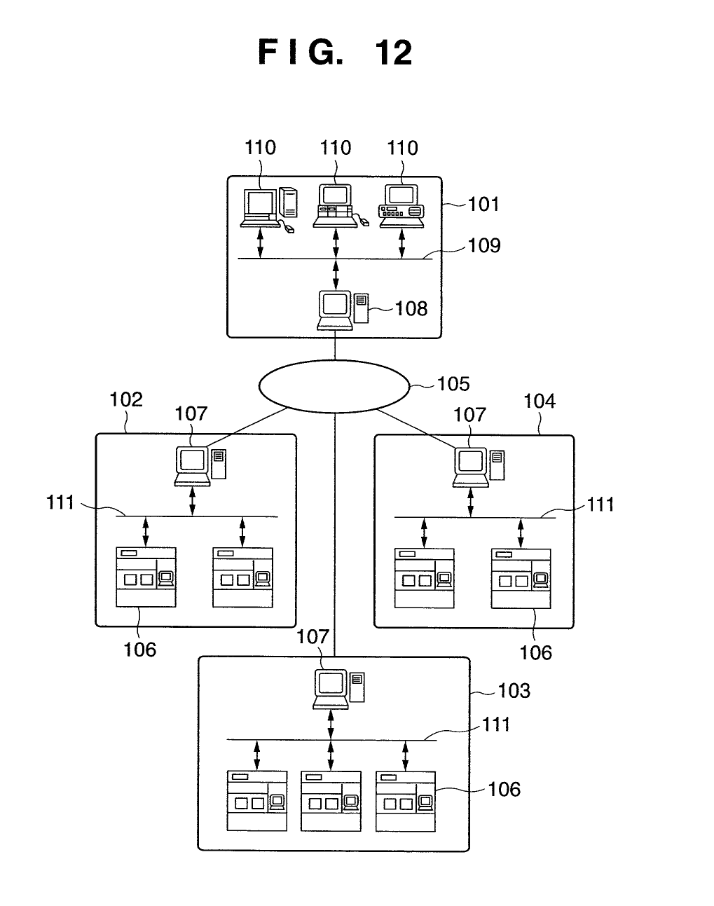

FIG. 12 shows the entire system cut out from an angle. In the figure, numeral 101 denotes the office of a vendor (apparatus maker) of semiconductor device fabrication apparatuses. As the semiconductor fabrication apparatuses, apparatuses in the semiconductor fabrication factory for various processes such as preprocess apparatuses (lithography apparatuses including an exposure apparatus, a resist processing apparatus and an etching apparatus, a heat processing apparatus, a film forming apparatus, a smoothing apparatus and the like) and postprocess apparatuses (an assembly apparatus, an inspection apparatus and the like) are used. The office 101 has a host management system 108 to provide a maintenance database for the fabrication apparatus, plural operation terminal computers 110, and a local area network (LAN) 109 connecting them to construct an Intranet or the like. The host management system 108 has a gateway for connection between the LAN 109 and the Internet 105 as an external network and a security function to limit access from the outside.

On the other hand, numerals 102 to 104 denote fabrication factories of semiconductor makers as users of the fabrication apparatuses. The fabrication factories 102 to 104 may belong to different makers or may belong to the same maker (e.g., preprocess factories and postprocess factories). The respective factories 102 to 104 are provided with plural fabrication apparatuses 106, a local area network (LAN) 111 connecting the apparatuses to construct an Intranet or the like, and a host management system 107 as a monitoring apparatus to monitor operating statuses of the respective fabrication apparatuses 106. The host management system 107 provided in the respective factories 102 to 104 has a gateway for connection between the LAN 111 and the Internet 105 as the external network. In this arrangement, the host management system 108 on the vendor side can be accessed from the LAN 111 in the respective factories via the Internet 105, and only limited user(s) can access the system by the security function of the host management system 108. More particularly, status information indicating the operating statuses of the respective fabrication apparatuses 106 (e.g. problem of fabrication apparatus having trouble) is notified from the factory side to the vendor side via the Internet 105, and maintenance information such as response information to the notification (e.g. information indicating measure against the trouble, or remedy software or data), latest software, help information and the like is received from the vendor side via the Internet. The data communication between the respective factories 102 to 104 and the vendor 101 and data communication in the LAN 111 of the respective factories are performed by using a general communication protocol (TCP/IP). Note that as the external network, a private-line network (ISDN or the like) with high security against access from outsiders may be used in place of the Internet.

Further, the host management system is not limited to that provided by the vendor, but a database constructed by the user may be provided on the external network, to provide the plural user factories with access to the database.

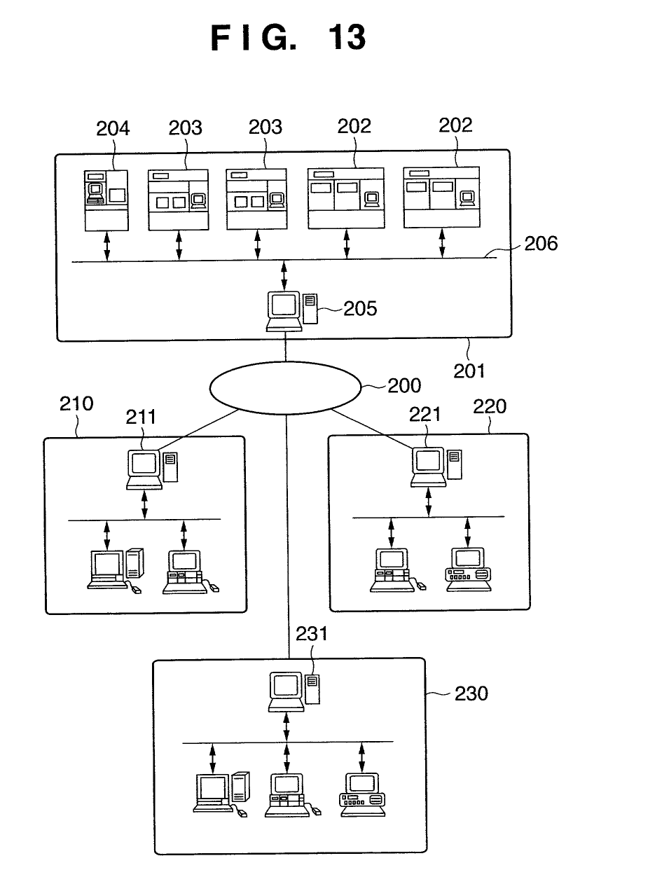

FIG. 13 is a conceptual diagram showing the entire system of the present embodiment cut out from another angle different from that in FIG. 12. In the above example, the plural user factories respectively having fabrication apparatuses and the management system of the apparatus vendor are connected via the external network, and data communication is performed for production management for the respective factories and transmission of information on at least one fabrication apparatus. In this example, a factory having fabrication apparatuses of plural vendors is connected with management systems of the respective vendors of the fabrication apparatuses via the external network, and data communication is performed for transmission of maintenance information for the respective fabrication apparatuses. In the figure, numeral 201 denotes a fabrication factory of fabrication apparatus user (semiconductor device maker). In the factory fabrication line, fabrication apparatuses for various processes, an exposure apparatus 202, a resist processing apparatus 203 and a film forming apparatus 204, are used. Note that FIG. 13 shows only the fabrication factory 201, however, actually plural factories construct the network. The respective apparatuses of the factory are connected with each other by a LAN 206 to construct an Intranet, and a host management system 205 performs operation management of the fabrication line.

On the other hand, the respective offices of vendors (apparatus makers), an exposure apparatus maker 210, a resist processing apparatus maker 220, a film forming apparatus maker 230 have host management systems 211, 221 and 231 for remote maintenance for the apparatuses, and as described above, the systems have the maintenance database and the gateway for connection to the external network. The host management system 205 for management of the respective apparatuses in the user fabrication factory is connected with the respective vendor management systems 211, 221 and 231 via the Internet or private-line network as an external network 200. In this system, if one of the fabrication apparatuses of the fabrication line has a trouble, the operation of the fabrication line is stopped. However, the trouble can be quickly removed by receiving the remote maintenance service from the vendor of the apparatus via the Internet 200, thus the stoppage of the fabrication line can be minimized.

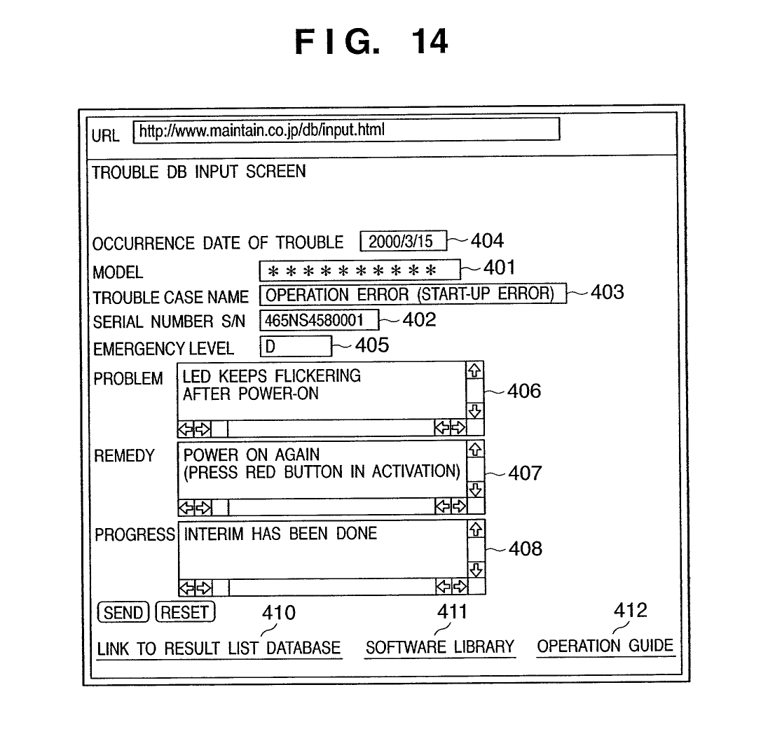

The respective fabrication apparatuses installed in the semiconductor fabrication factory have a display, a network interface and a computer to execute network access software stored in a memory and device operation software. As a memory, an internal memory, a hard disk or a network file server may be used. The network access software, including a specialized or general web browser, provides a user interface screen image as shown in FIG. 14 on the display. An operator who manages the fabrication apparatuses in the factory checks the screen image and inputs information of the fabrication apparatus, a model 401, a serial number 402, a trouble case name 403, a date of occurrence of trouble 404, an emergency level 405, a problem 406, a remedy 407 and a progress 408, into input fields on the screen image. The input information is transmitted to the maintenance database via the Internet, and appropriate maintenance information as a result is returned from the maintenance database and provided on the display. Further, the user interface provided by the web browser realizes hyper link functions 410 to 412 as shown in the figure, and the operator accesses more detailed information of the respective items, downloads latest version software to be used in the fabrication apparatus from a software library presented by the vendor, and downloads operation guidance (help information) for the operator's reference. The maintenance information provided from the maintenance database includes the information on the above-described present invention, and the software library provides latest version software to realize the present invention.

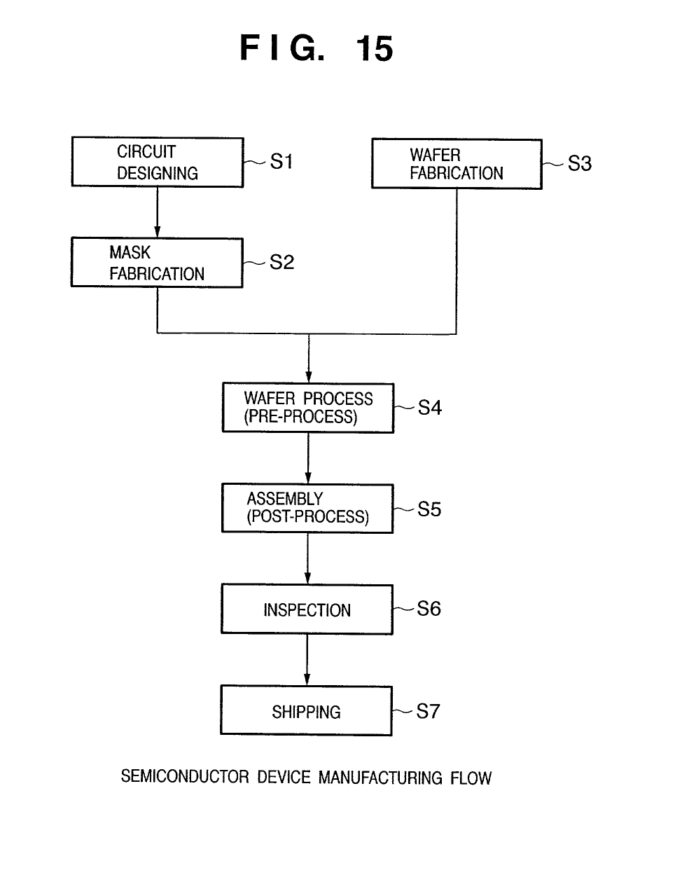

Next, a semiconductor device fabrication process utilizing the above-described production system will be described. FIG. 15 shows a flow of the entire semiconductor fabrication process. At step S1 (circuit designing), a circuit designing of the semiconductor device is performed. At step S2 (mask fabrication), a mask where the designed circuit pattern is formed is fabricated. On the other hand, at step S3 (wafer fabrication), a wafer is fabricated using silicon or the like. At step S4 (wafer process) called preprocess, the above mask and wafer are used. An actual circuit is formed on the wafer by lithography. At step S5 (assembly) called postprocess, a semiconductor chip is formed by using the wafer at step S4. The postprocess includes processing such as an assembly process (dicing and bonding) and a packaging process (chip sealing). At step S6 (inspection), inspections such as an operation test and a durability test are performed on the semiconductor device assembled at step S5. The semiconductor device is completed through these processes, and it is shipped (step S7). The preprocess and the postprocess are independently performed in specialized factories, and maintenance is made for these factories by the above-described remote maintenance system. Further, data communication is performed for production management and/or apparatus maintenance between the preprocess factory and the postprocess factory via the Internet or private-line network.

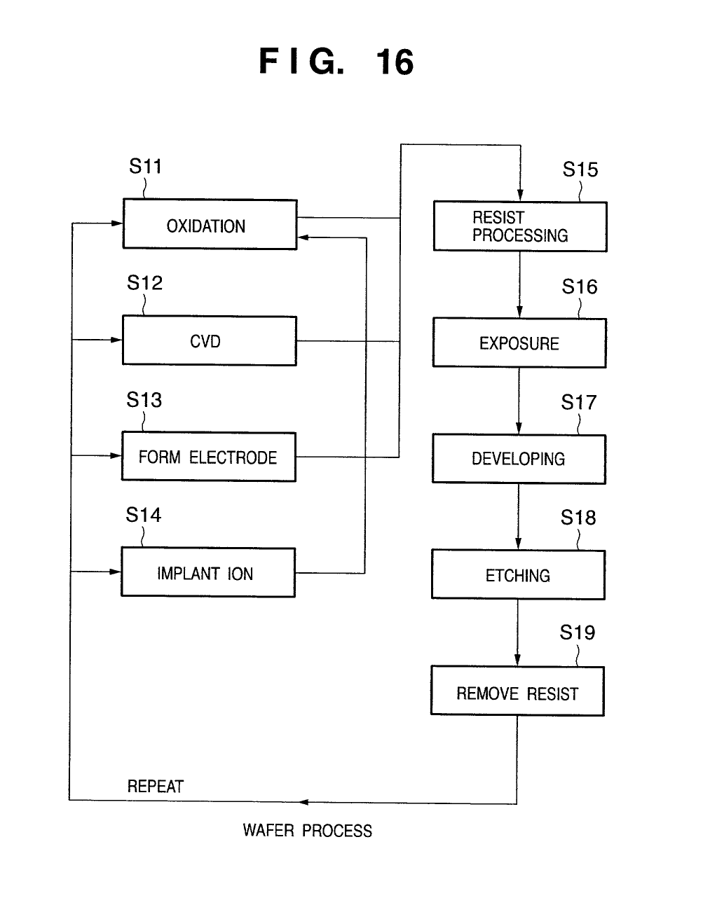

FIG. 16 shows a more detailed flow of the wafer process. At step S11 (oxidation), the surface of the wafer is oxidized. At step S12 (CVD), an insulating film is formed on the surface of the wafer. At step S13 (electrode formation), electrodes are formed by vapor deposition on the wafer. At step S14 (ion implantation), ions are injected into the wafer. At step S15 (resist processing), the wafer is coated with photoresist. At step S16 (exposure), the above-described exposure apparatus exposure-transfers the circuit pattern of the mask onto the wafer. At step S17 (development), the exposed wafer is developed. At step S18 (etching), portions other than the resist image are etched. At step S19 (resist stripping), the resist unnecessary after the etching is removed. These steps are repeated, thereby multiple circuit patterns are formed on the wafer. As maintenance is performed on the fabrication apparatuses used in the respective steps by the above-described remote maintenance system, trouble is prevented, and even if it occurs, quick recovery can be made. In comparison with the conventional art, the productivity of the semiconductor device can be improved.

[Other Embodiment]

The present invention includes a case where the object of the present invention can be also achieved by providing software program for performing the functions of the above-described embodiments to a system or an apparatus from a remote position, and reading and executing the program code with a computer of the system or apparatus. In such case, the form of the software is not necessary a program as long as it has a function of program.

Accordingly, to realize the functional processing of the present invention by the computer, the program code itself installed in the computer realizes the present invention. That is, the claims of the present invention include a computer program itself to realize the functional processing of the present invention.

In such case, other form of program such as a program executed by object code, interpreter and the like, or script data to be supplied to an OS (Operating System), as long as it has the function of program.

As a storage medium for providing the program, a floppy disk, a hard disk, an optical disk, a magneto-optical disk, an MO, a CD-ROM, a CD-R, a CD-RW, a magnetic tape, a non-volatile type memory card, a ROM, a DVD (a DVD-ROM and a DVD-R) or the like can be used.

Further, the program may be provided by accessing a home page on the Internet by using a browser of a client computer, and downloading the computer program itself of the present invention or a compressed file having an automatic installation function from the home page to a storage medium such as a hard disk. Further, the present invention can be realized by dividing program code constructing the program of the present invention into plural files, and downloading the respective files from different home pages. That is, the claims of the present invention also include a WWW server holding the program file to realize the functional processing of the present invention to be downloaded to plural users.

Further, the functional processing of the present invention can be realized by encrypting the program of the present invention and storing the encrypted program into a storage medium such as a CD-ROM, delivering the storage medium to users, permitting a user who satisfied a predetermined condition to download key information for decryption from the home page via the Internet, and the user's executing the program by using the key information and installing the program into the computer.

Furthermore, besides the functions according to the above embodiments are realized by executing the read program by a computer, the present invention includes a case where an OS or the like working on the computer performs a part or entire actual processing in accordance with designations of the program code and realizes functions according to the above embodiments.

Furthermore, the present invention also includes a case where, after the program code read from the storage medium is written in a function expansion board which is inserted into the computer or in a memory provided in a function expansion unit which is connected to the computer, CPU or the like contained in the function expansion board or unit performs a part or entire process in accordance with designations of the program code and realizes functions of the above embodiments.

Thus, in accordance with the embodiments as described above, it is possible to raise the throughput of exposure by increasing laser oscillation frequency, depending upon the exposure conditions, without raising the cooling performance of a pulsed laser such as an excimer laser or the performance of air conditioning facilities in the environment in which the exposure apparatus is used.

The present invention is not limited to the above embodiments and various changes and modifications can be made within the spirit and scope of the present invention. Therefore, to apprise the public of the scope of the present invention, the following claims are made.

What is claimed is:

1. An exposure apparatus for emitting exposing light from a light source and transferring a pattern on a reticle to a photosensitive substrate by exposing the substrate to the pattern, comprising:
a determination unit for determining whether a condition wherein optical quality of the exposing light emitted by the light source will decline has been met; and
a control unit for controlling emission of the exposing light, based upon the result of the determination by said determination unit, so as to suppress a decline in the optical quality of the light source.

2. The apparatus according to claim 1, wherein said determination unit determines whether a condition wherein temperature of the light source rises has been met, and said control unit controls emission of the exposing light so as to suppress a rise in the temperature of the light source.

3. The apparatus according to claim 1, further comprising a stage that can be moved with respect to a demagnifying exposure optical system while holding the photosensitive substrate;
wherein said stage is moved sequentially to expose a plurality of areas of the photosensitive substrate to the pattern, which has been formed on the reticle, via the demagnifying projection optical system.

4. The apparatus according to claim 1, wherein the light source produces a pulsed light emission and said control unit causes the light source to produce a pulsed light emission at a predetermined timing and controls the timing of the pulsed light emission upon comparing the number of light pulses emitted per unit time with a predetermined number of pulses.

5. The apparatus according to claim 4, wherein said control unit calculates the number of light pulses emitted per unit time based upon the pulsed light emission time of the light source and traveling time of said stage.

6. The apparatus according to claim 4, wherein if the number of light pulses emitted per unit time exceeds the predetermined number of pulses, said control unit lowers light-emission frequency of the light source, or provides a light-emission quiescent period or prolongs an existing light-emission quiescent period.

7. The apparatus according to claim 3, wherein the light source produces a pulsed light emission, said control unit controls the light-emission intensity of the light source based upon a parameter value applied to the light source, and reduces light-emission intensity of the light source by changing the parameter value if the number of light pulses emitted per unit time exceeds the predetermined number of pulses.

8. The apparatus according to claim 7, wherein said control unit calculates the number of light pulses emitted per unit time based upon the pulsed light emission time of the light source and the traveling time of said stage.

9. The apparatus according to claim 7, wherein the parameter value is a value of voltage applied to the light source.

10. The apparatus according to claim 5, wherein said control unit calculates the number of light pulses emitted per unit time before start of the exposure operation.

11. The apparatus according to claim 4, further comprising a counting unit for counting the number of light pulses emitted per unit time.

12. The apparatus according to claim 4, further comprising a measuring unit for measuring temperature or optical quality of the light source;
wherein said control unit controls timing of the pulsed light emission in such a manner that the temperature or optical quality of the light source will not fall outside a predetermined range.

13. The apparatus according to claim 7, further comprising a measuring unit for measuring temperature or optical quality of the light source;
wherein said control unit reduces light-emission intensity of the light source by changing the parameter value if the temperature or optical quality of the light source falls outside the predetermined range.

14. The apparatus according to claim 13, wherein the parameter value is a value of voltage applied to the light source.

15. The apparatus according to claim 12, further comprising an alarm unit for outputting an alarm signal;
wherein said alarm unit outputs the alarm signal if the temperature or optical quality of the light source falls outside the predetermined range.

16. An exposure method for emitting exposing light from a light source and transferring a pattern on a reticle to a photosensitive substrate by exposing the substrate to the pattern, comprising:
a determination step of determining whether a condition wherein optical quality of the exposing light emitted by the light source will decline has been met; and
a control step of controlling emission of the exposing light, based upon the result of the determination at said determination step, so as to suppress a decline in the optical quality of the light source.

17. The method according to claim 16, wherein said determination step determines whether a condition wherein temperature of the light source rises has been met, and said control step controls emission of the exposing light so as to suppress a rise in the temperature of the light source.

18. The method according to claim 16, wherein a stage that can be moved with respect to a demagnifying exposure optical system while holding the photosensitive substrate is provided;
said stage being moved sequentially to expose a plurality of areas of the photosensitive substrate to the pattern, which has been formed on the reticle, via the demagnifying projection optical system.

19. The method according to claim 16, wherein the light source produces a pulsed light emission and said control step causes the light source to produce a pulsed light emission at a predetermined timing and controls the timing of the pulsed light emission upon comparing the number of light pulses emitted per unit time with a predetermined number of pulses.

20. The method according to claim 19, wherein said control step calculates the number of light pulses emitted per unit time based upon the pulsed light emission time of the light source and traveling time of said stage.

21. The method according to claim 19, wherein if the number of light pulses emitted per unit time exceeds the predetermined number of pulses, said control step lowers light-emission frequency of the light source, or provides a light-emission quiescent period or prolongs an existing light-emission quiescent period.

22. The method according to claim 18, wherein the light source produces a pulsed light emission, said control step controls the light-emission intensity of the light source based upon a parameter value applied to the light source, and reduces light-emission intensity of the light source by changing the parameter value if the number of light pulses emitted per unit time exceeds the predetermined number of pulses.

23. The method according to claim 22, wherein said control step calculates the number of light pulses emitted per unit time based upon the pulsed light emission time of the light source and the traveling time of said stage.

24. The method according to claim 22, wherein the parameter value is a value of voltage applied to the light source.

25. The method according to claim 20, wherein said control step calculates the number of light pulses emitted per unit time before start of the exposure operation.

26. The method according to claim 19, further comprising a counting step of counting the number of light pulses emitted per unit time.

27. The method according to claim 19, further comprising a measuring step of measuring temperature or optical quality of the light source;
wherein said control step controls timing of the pulsed light emission in such a manner that the temperature or optical quality of the light source will not fall outside a predetermined range.

28. The method according to claim 22, further comprising a measuring step of measuring temperature or optical quality of the light source;
wherein said control step reduces light-emission intensity of the light source by changing the parameter value if the temperature or optical quality of the light source falls outside the predetermined range.

29. The method according to claim 28, wherein the parameter value is a value of voltage applied to the light source.

30. The method according to claim 27, further comprising an alarm step of outputting an alarm signal;
wherein said alarm step outputs the alarm signal if the temperature or optical quality of the light source falls outside the predetermined range.

31. A method of manufacturing a semiconductor device comprising the steps of:
installing a group of manufacturing apparatus for various processes in a semiconductor manufacturing plant; and
manufacturing a semiconductor device by a plurality of processes using the group of manufacturing apparatus;
wherein the group of manufacturing apparatus includes an exposure apparatus having:
a determination unit for determining whether a condition wherein optical quality of the exposing light emitted by the light source will decline has been met; and
a control unit for controlling emission of the exposing light, based upon the result of the determination by said determination unit, so as to suppress a decline in the optical quality of the light source.

32. The method according to claim 31, further comprising the steps of:
interconnecting the group of semiconductor manufacturing apparatus by a local-area network; and
communicating information, which relates to at least one of the manufacturing apparatus in the group thereof, between the local area network and an external network outside the plant by data communication.

33. The method according to claim 32, wherein maintenance information for the manufacturing apparatus is obtained by accessing, by data communication via the external network, a database provided by a vendor or user of said exposure apparatus, or production management is performed by data communication with a semiconductor manufacturing plant other than said semiconductor manufacturing plant via the external network.

34. A semiconductor manufacturing plant comprising:
a group of manufacturing apparatus for various processes inclusive of an exposure apparatus;
a local-area network for interconnecting said group of manufacturing apparatus; and
a gateway for making it possible to access, from said local-area network, an external network outside the plant;
whereby information relating to at least one of said manufacturing apparatus in the group thereof can be communicated by data communication;
said exposure apparatus having:
a determination unit for determining whether a condition wherein optical quality of the exposing light emitted by the light source will decline has been met; and
a control unit for controlling emission of the exposing light, based upon the result of the determination by said determination unit, so as to suppress a decline in the optical quality of the light source.

35. A method of maintaining an exposure apparatus installed in a semiconductor manufacturing plant, said exposure apparatus having a determination unit for determining whether a condition wherein optical quality of the exposing light emitted by the light source will decline has been met, and a control unit for controlling emission of the exposing light, based upon the result of the determination by said determination unit, so as to suppress a decline in the optical quality of the light source; said method comprising the steps of:
providing a maintenance database, which is connected to an external network of the semiconductor manufacturing plant, by a vendor or user of the exposure apparatus;
allowing access to the maintenance database from within the semiconductor manufacturing plant via the external network; and
transmitting maintenance information, which is stored in the maintenance database, to the side of the semiconductor manufacturing plant via the external network.

36. An exposure apparatus comprising:
a determination unit for determining whether a condition wherein optical quality of the exposing light emitted by the light source will decline has been met;
a control unit for controlling emission of the exposing light, based upon the result of the determination by said determination unit, so as to suppress a decline in the optical quality of the light source;
a display;
a network interface; and
a computer for executing network software;
wherein maintenance information relating to said exposure apparatus is capable of being communicated by data communication via a computer network.

37. The apparatus according to claim 36, wherein the network software provides said display with a user interface for accessing a maintenance database, which is connected to an external network of a plant at which said exposure apparatus has been installed, and which is supplied by a vendor or user of said exposure apparatus, thereby making it possible to obtain information from said database via said external network.
